(19) United States
(12) Patent Application Publication
(10) Pub. No.: US 2025/0136750 A1
(43) Pub. Date: May 1, 2025

(54) POLYESTER RESIN COMPOSITION FOR FILM CONTAINING TITANIUM-BASED CATALYST AND PREPARATION METHOD THEREFOR

(71) Applicant: TORAY ADVANCED MATERIALS KOREA INC., Gumi-si, Gyeongsangbuk-do (KR)

(72) Inventors: Song Jung HAN, Gumi-si, Gyeongsangbuk-do (KR); Dohyun KIM, Gumi-si, Gyeongsangbuk-do (KR)

(21) Appl. No.: 18/836,431

(22) PCT Filed: Jan. 11, 2023
(86) PCT No.: PCT/KR2023/000483

§ 371 Date: Aug. 7, 2024

(30) Foreign Application Priority Data
Feb. 7, 2022 (KR) 10-2022-0015652

(51) Int. Cl. C08G 63/183; C08G 63/85; C08J 5/18; C08K 5/521

(52) U.S. Cl. CPC C08G 63/183; C08G 63/85; C08J 5/18; C08K 5/521; C08J 2367/06

(57) ABSTRACT

The present invention enables a polycondensation reaction of polyester at a low temperature to lead to an improvement in thermal stability as well as a high degree of polymerization in a polyester resin, so that a polyester resin with a minimized end group (carboxyl group) and a small content of foreign matter can be produced. In addition, when a film is manufactured using the polyester resin, a film with a uniform thickness can be produced because no gap is formed between the drum surface and a sheet-like product even at a high rotational speed due to an excellent electrostatic application property and a small melt specific resistance of the polyester resin, and a film with high transparency can be produced due to a small content of foreign matter.

### TECHNICAL FIELD

The present invention relates to a polyester composition for films and a polyester resin for films manufactured therefrom.

### BACKGROUND ART

Polyester is a polymer obtained by polycondensation of a compound formed when an ester is formed between a carboxyl group and a hydroxyl group. Typically, due to its excellent mechanical and chemical properties, polyester, which results from polymerization of terephthalic acid and ethylene glycol, has high industrial value and is widely used in fibers, films, sheets, and hollow molded products.

In particular, since films using a polyester resin have excellent mechanical properties, thermal properties, chemical resistance, and electrical properties, they are widely used in various industrial fields such as magnetic recording media, condensers, optics, and general industrial purposes.

However, when a film is manufactured using the polyester resin, the following process problems may occur.

First, in order to manufacture a film using a polyester resin, an electrostatic application casting method in which high voltage is applied and a sheet-type film is brought into close contact with a rotating cooling drum should be used, but the polyester resin has low electrostatic application properties, which may reduce the close contact between the film and the drum, and in turn, the physical properties of the film itself, such as the thickness uniformity, transparency, and surface smoothness of the manufactured film, may deteriorate.

Second, in order to mold and process the film manufactured using the polyester resin, melt extrusion molding is required at a temperature above the melting point of 250 to 300° C., and only a trace amount of oxygen introduced during the high temperature process may generate a large number of foreign substances due to oxidative decomposition, which may decrease the transparency of the film. To compensate for these shortcomings of polyester resin, various catalysts are generally used in the polycondensation reaction of polyester resin, and antimony compounds or germanium compounds are mostly used on an industrial scale.

However, polyester resins polycondensed using antimony compounds as catalysts have a unique black color and there are concerns about toxicity and environmental pollution, and polyester resins polycondensed using germanium compounds as catalysts have difficulty in industrial mass production due to the scarcity of germanium itself. As an alternative, titanium (Ti)-based catalysts may overcome the problems of the antimony and germanium catalysts, but when the Ti-based catalyst is used as a polyester polycondensation catalyst, the polyester itself turns yellow and the melt thermal stability may become unstable. In particular, when titanium-based compound catalysts are used in films, the formation of particles, such as by-products, is not suppressed, which may affect the lubricity and smoothness of the film and ultimately cause the film to rupture.

Therefore, there is an urgent need to develop a catalyst that can overcome the above-described process problems of polyester resin and solve the inherent problems of titanium-based compound catalysts when replacing antimony compounds or germanium compounds.

### DISCLOSURE

### Technical Problem

The present invention was developed to overcome the above-described problems, and one object of the present invention is to provide a polyester resin composition for films, which is able to be manufactured into a polyester resin that improves the thermal stability of a polyester resin by enabling a polycondensation reaction of polyester at a low temperature, and is capable of preparing a polyester resin with minimized terminal groups (carboxyl groups) and a low content of foreign substances due to having a high degree of polymerization.

Another object of the present invention is to provide a uniform and highly transparent film manufactured using a polyester resin according to the present invention because no gap is formed between the drum surface and the sheet-type product even at a high rotational speed due to the excellent electrostatic applicability and low melt resistivity of the polyester resin.

### Technical Solution

To solve the above-described problems, one embodiment of the present invention provides a polyester resin composition for films, which includes a polyester resin, a titanium-based chelate catalyst, a pinning agent, and a phosphorus-based compound and satisfies all of the following relational expressions (1) to (3):

$$M = 1 to 150 ppm \qquad ( 1 )$$

$$T = 5 to 45 ppm \qquad ( 2 )$$

$$R = 0.01 to 10 MΩ \cdot cm \qquad ( 3 )$$

wherein M refers to the total content of metal components excluding phosphorus (P) in the polyester resin composition,

T refers to the content of titanium based on elemental titanium, and

R refers to melt resistivity.

According to an embodiment of the present invention, the composition may be a polyester resin composition for films, which satisfies the following relational expression (4):

$$P / M = 0.1 to 0.6 \qquad ( 4 )$$

wherein P refers to the amount of elemental phosphorus in the phosphorus-based compound.

The titanium-based chelate catalyst of the polyester resin composition for films may be a reaction product of titanium-(IV)-alkoxide represented by the following Chemical Formula 1 and alpha-hydroxy carboxylic acid:

Ti—(OR₁)₄ [Chemical Formula 1]

wherein R₁ is a C₁ to C₆ alkyl group and an isomer thereof.

The reaction product of the polyester resin composition for films may be titanium alpha-hydroxy carboxylate represented by the following Chemical Formula 2:

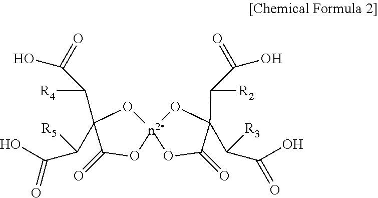

wherein R₂ to R₅ are each independently hydrogen or a C₁ to C₆ alkyl group and an isomer thereof.

The phosphorus-based compound of the polyester resin composition for films may be represented by the following Chemical Formula 3 and may preferably be triethyl phosphate (TEP):

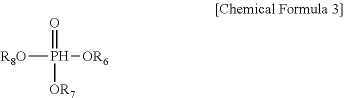

wherein R₆ to R₈ are each independently a C₁ to C₆ alkyl group and an isomer thereof.

The pinning agent of the polyester resin composition for films may be a magnesium (Mg) compound.

The above-described composition may further include a coloring agent including blue and red dyes in an amount of 1 to 10 ppm based on the total weight of the polyester resin composition.

Another embodiment of the present invention provides a film manufactured using any one polyester resin composition selected from the polyester resin compositions described above.

Still another embodiment of the present invention provides a method of preparing a polyester resin for films, which includes (1) preparing an esterification reaction product from the esterification reaction of an acid and a diol component, and (2) preparing a polyester resin by adding a titanium-based chelate catalyst, a pinning agent, and a phosphorus-based compound to the prepared esterification reaction product, wherein step (2) is for preparing a polyester resin having a melt resistivity of 0.01 to 10 MΩ·cm by combining the composition of the titanium-based chelate catalyst, the pinning agent, and the phosphorus-based compound.

Step (2) of the method may be for preparing a polyester resin for films having 1 to 45 terminal carboxyl groups by combining the composition of the titanium-based chelate catalyst, the pinning agent, and the phosphorus-based compound.

The titanium-based chelate catalyst of the method may be a reaction product of titanium-(IV)-alkoxide represented by the following Chemical Formula 1 and alpha-hydroxy carboxylic acid, and the phosphorus-based compound may be represented by the following Chemical Formula 3:

Ti—(OR₁)₄ [Chemical Formula 1]

wherein R₁ is each independently a C₁ to C₆ alkyl group and an isomer thereof, and at least one of them is not hydrogen,

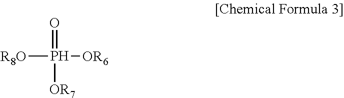

wherein R₆ to R₈ are each independently a C₁ to C₆ alkyl group and an isomer thereof.

The reaction product may be titanium alpha-hydroxy carboxylate represented by the following Chemical Formula 2:

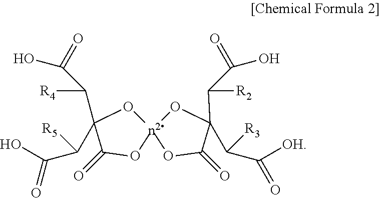

wherein R₂ to R₅ are each independently hydrogen or a C₁ to C₆ alkyl group and an isomer thereof.

### Advantageous Effects

The polyester resin composition using the titanium-based chelate catalyst according to the present invention can be manufactured into a polyester resin that improves the thermal stability of a polyester resin by enabling a polycondensation reaction of polyester at a low temperature, and is capable of preparing a polyester resin with minimized terminal groups (carboxyl groups) and a low content of foreign substances due to having a high degree of polymerization.

Since the polyester resin according to the present invention has an excellent electrostatic application property and a low melt specific resistance, when a film is manufactured using the polyester resin, a film with a uniform thickness can be manufactured because no gap is formed between the drum surface and the sheet-type product even at a high rotational speed, and a highly transparent film can be manufactured due to a low content of foreign substances.

### BEST MODES OF THE INVENTION

Hereinafter, embodiments of the present invention will be described in detail so that those skilled in the art can easily implement the present invention. The present invention may be implemented in various forms and is not limited to the embodiments described herein.

As described above, since conventional polyester resins generally have excellent chemical resistance, they are widely used, but the film manufacturing process using them has problems due to the unique physical properties of polyester resin, and accordingly, catalysts have been used to overcome the problems. However, previously introduced catalysts had difficulties in industrial production in terms of color, productivity, environmental pollution, and economical aspects.

To solve the problems, the present invention provides a polyester resin composition for films, which includes a polyester resin polycondensate, a titanium-based chelate catalyst, a pinning agent, and a phosphorus-based compound and satisfies all of the following relational expressions (1) to (3):

$$M = 1 to 150 ppm \qquad ( 1 )$$

$$T = 5 to 45 ppm \qquad ( 2 )$$

$$R is 10 MΩ \cdot cm or less \qquad ( 3 )$$

wherein M refers to the total content of metal components excluding phosphorus (P) in the polyester resin composition,

T refers to the content of titanium based on elemental titanium, and

R refers to melt resistivity.

In this way, the physical properties of the polyester resin itself may be improved and the uniformity and transparency of the film manufactured therefrom may also be improved.

Hereinafter, the present invention will be described in detail.

The polyester resin polycondensate may be produced through an esterification reaction of an acid component and a diol component.

The polymerization of the acid component and the diol component may be carried out under conditions commonly used in esterification polymerization in the art, and for example, by stirring at a speed of 40 to 80 rpm at 200 to 260° C. for 150 to 240 minutes, but is not limited thereto.

The acid component includes terephthalic acid, and may further include an aromatic polyhydric carboxylic acid having 6 to 14 carbon atoms other than terephthalic acid, an aliphatic polyhydric carboxylic acid having 2 to 14 carbon atoms, or a sulfonic acid metal salt other than terephthalic acid.

The aromatic polyhydric carboxylic acid having 6 to 14 carbon atoms is an acid component used for the production of polyester, and although any acid known in the art may be used without limitation, it may preferably be one or more selected from the group consisting of dimethyl terephthalate, isophthalic acid, and dimethyl isophthalate, and more preferably, may be isophthalic acid in terms of the reaction stability with terephthalic acid, ease of handling, and economical aspects.

The aliphatic polyhydric carboxylic acid having 2 to 14 carbon atoms is an acid component used for the production of polyester, and although any acid known in the art may be used without limitation, non-limiting examples thereof may be one or more selected from the group consisting of oxalic acid, malonic acid, succinic acid, glutaric acid, adipic acid, suberic acid, citric acid, pimelic acid, azelaic acid, sebacic acid, nonanoic acid, decanoic acid, dodecanoic acid, and hexanodecanoic acid.

The sulfonic acid metal salt may be sodium 3,5-dicarbomethoxybenzene sulfonate.

Next, the diol component, which is one of the monomers of the esterification reaction product, will be described.

The diol component may each independently include an aliphatic diol component having 2 to 14 carbon atoms and polyethylene glycol. Specifically, the aliphatic diol component may be one or more selected from the group consisting of ethylene glycol, diethylene glycol, neopentyl glycol, 1,3-propanediol, 1,4-butanediol, 1,6-hexanediol, propylene glycol, trimethyl glycol, tetramethylene glycol, pentamethylene glycol, hexamethylene glycol, heptamethylene glycol, octamethylene glycol, nonamethylene glycol, decamethylene glycol, undecamethylene glycol, dodecamethylene glycol, and tridecamethylene glycol, but is not limited thereto. It may preferably be one or more of ethylene glycol, diethylene glycol, neopentyl glycol, 1,3-propanediol, 1,4-butanediol, and 1,6-hexanediol.

The titanium-based chelate catalyst is a titanium-based chelate compound in which other materials are bonded around titanium, which is the central atom. Since titanium-based chelate compounds are stable even in the presence of water molecules, they are not deactivated even when added before the esterification reaction, in which a large amount of water is produced as a by-product, and thus, the esterification and polycondensation reactions may be shortened compared to conventional reactions, and coloring due to yellowing may be suppressed. Conventionally, titanium alkoxide was a water-insoluble material and is difficult to handle when applied in the process. The titanium-based chelate catalyst applied in the present invention is a water-soluble material and stable even in the presence of water molecules, and has high activity during polymerization.

The titanium-based chelate catalyst may be included in an amount of 10 to 15 ppm based on the obtained atoms, which is preferable because thermal stability and color are improved. When the titanium-based chelate catalyst is included in an amount less than 10 ppm based on titanium atoms, it may be difficult to properly promote the esterification reaction, and when the titanium-based chelate catalyst is included in an amount exceeding 15 ppm, reactivity is promoted, but there may be a problem of coloring.

The titanium-based chelate catalyst may be those commonly used, and the titanium compound may have one or more substituents selected from the group consisting of an alkoxy group, a phenoxy group, an acylate group, an amino group, and a hydroxyl group. For example, a tetraalkoxy group, such as tetraethoxide, tetrapropoxide, tetraisopropoxide, tetrabutoxide, and tetra-2-ethyl hexoxide, a B-diketone-based functional group, a hydroxy polycarboxylic acid-based functional group, such as lactic acid, malic acid, tartaric acid, salicylic acid, and citric acid, and a keto ester-based functional group, such as methyl acetoacetate and ethyl acetoacetate, may be used, and examples of the phenoxy group include phenoxy, cresylate, and the like. Examples of the acylate group may be a tetraacylate group, such as lactate, stearate and the like, a polyvalent carboxylic acid-based functional group, such as phthalic acid, trimellitic acid, trimesic acid, hemimellitic acid, pyromellitic acid, oxalic acid, malonic acid, succinic acid, glutaric acid, adipic acid, sebacic acid, maleic acid, phthalic acid, cyclohexanedicarboxylic acid, anhydrides thereof, and the like, ethylenediaminetetraacetic acid, nitrilo-3-propionic acid, carboxyiminodiacetic acid, carboxymethyliminodipropionic acid, diethylenetriaminopentaacetic acid, triethylenetetramine hexaacetic acid, iminodiacetic acid, iminodipropionic acid, hydroxyethyliminodiacetic acid, hydroxyethyliminodipropionic acid, methoxyethyl iminodiacetic acid, and the like, but is not limited thereto.

The titanium-based chelate catalyst may be preferably a reaction product of titanium-(IV)-alkoxide represented by the following Chemical Formula 1 and alpha-hydroxy carboxylic acid, which is advantageous in polymerization. In other words, conventional titanium alkoxide is a water-insoluble material and is difficult to handle when applied to the process, but the titanium-based chelate compound applied in the present invention is a water-soluble material and stable even in the presence of water molecules and has high activity during polymerization.

Ti—(OR₁)₄ [Chemical Formula 1]

Here, R₁ is hydrogen or a C₁ to C₆ alkyl group and an isomer thereof, and at least one of them is not hydrogen.

The reaction product may be titanium alpha-hydroxy carboxylate represented by the following Chemical Formula 2:

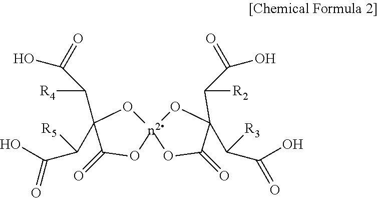

wherein R₂ to R₅ are each independently hydrogen or a C₁ to C₆ alkyl group.

In particular, it is the most preferable to use a compound represented by Chemical Formula 2 as the titanium-based chelate catalyst according to the present invention to maximize the effects such as low process temperatures, high degree of polymerization, heat resistance, and minimizing terminal groups. When a polyester polycondensation reaction is performed using a known titanium-based polyester catalyst rather than the titanium-based chelate catalyst represented by Chemical Formula 2 according to the present invention, the polyester itself may turn yellow and the melt thermal stability may become unstable.

Similarly, when a film is manufactured using a polyester resin, which is prepared using a known titanium-based polyester catalyst rather than the titanium-based chelate catalyst represented by Chemical Formula 2 according to the present invention, the formation of particles, such as by-products, may not be suppressed, affecting the lubricity and smoothness of the film, and thus the film may rupture.

Compared to conventional titanium-based chelate catalysts, since the titanium alpha-hydroxy carboxylate represented by Chemical Formula 2 is stable even in the presence of water molecules, the catalyst is not deactivated even when added before the esterification reaction, in which a large amount of water is produced as a by-product, and thus, the time for esterification and polycondensation reactions may be shortened compared to conventional reactions, and coloring due to yellowing may be suppressed. In addition, by enabling a polymerization reaction at a low temperature, the heat resistance of the polyester resin is improved, and a high degree of polymerization is exhibited, and thus, it is possible to prepare a polyester resin with minimized terminal groups (carboxyl groups) and a low content of foreign substances.

However, in order to obtain the desired effects of the present invention, the above-described titanium chelate needs to be used, and when a titanium chelate is coordinated or allowed to react with other types of compounds, the desired heat resistance and high degree of polymerization may not be obtained and the number of terminal groups increases, which may decrease physical properties due to the content of foreign substances. When the titanium-based chelate catalyst according to the present invention is applied, the metal content may be greatly reduced to 1/10 or less compared to the use of a conventional catalyst (Sb catalyst), thereby exhibiting excellent melt resistivity.

The pinning agent serves to suppress the formation of foreign substances, increase the degree of polymerization, and lower melt resistivity, when polyester undergoes a polycondensation reaction. In the present invention, commonly used pinning agents may be used, and although there is no particularly limitation, metal-based pinning agents may be preferably used, and more specifically, alkali metal compounds, alkaline earth metal compounds, manganese compounds, cobalt compounds, zinc compounds, and the like may be preferably used because of their high electrostatic activity. Specific examples thereof may include magnesium acetate, sodium acetate, calcium acetate, lithium acetate, calcium phosphate, magnesium oxide, magnesium hydroxide, magnesium alkoxide, manganese acetate, zinc acetate, and a mixture of one or more thereof. More preferably, the pinning agent may be a magnesium (Mg)-based compound.

The pinning agent may be included in the polyester resin composition at an amount of 10 to 100 ppm based on the used elements. When the content of the pinning agent is less than 10 ppm, high adhesion between the sheet-type product and the cooling drum does not occur during film casting, resulting in an uneven film thickness, and the film manufacturing efficiency decreases because the rotational speed is not increased during casting. When the content of the pinning agent exceeds 100 ppm, the metal content increases, which may cause defects during film manufacturing, leading to problems with the product and the process such as poor appearance of the product. More preferably, the pinning agent may be included in an amount of 20 to 80 ppm.

The phosphorus compound is included in the polyester resin composition of the present invention to serve as a thermal stabilizer in the polycondensation process.

The phosphorus compound may be phosphoric acid, phosphorous acid, phosphonic acid, and a derivative thereof, and may be, as a specific example, phosphoric acid, trimethyl phosphate, tributyl phosphate, triphenyl phosphate, monomethyl phosphate, dimethyl phosphate, monobutyl phosphate, dibutyl phosphate, phosphorous acid, trimethyl phosphite, tributyl phosphite, methyl phosphonic acid, dimethyl methylphosphonate, dimethyl ethylphosphonate, diethylphosphono-ethyl acetate, dimethyl phenyl phosphonate, diethyl phenyl phosphonate, phenyl phosphonic acid and the like. Among them, the phosphorus compound may preferably be diethylphosphono-ethyl acetate and trimethyl phosphate, and more preferably, may be represented by Chemical Formula 3 below, and more preferably, it may be triethyl phosphate (TEP).

When the phosphorus-based compound represented by Chemical Formula 3 below according to the present invention is used as a thermal stabilizer, it helps the activity of the titanium catalyst more than when using the known phosphorus-based compound described above. When a known phosphorus-based compound, other than the phosphorus-based compound represented by Chemical Formula 3 below, is used, the purpose of the present invention, which is to improve the heat resistance of the polyester resin and minimize the melt resistivity of the polyester resin, cannot be achieved.

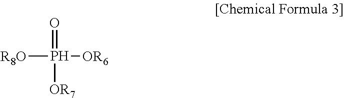

Here, R₆ to R₈ are each independently hydrogen or a C₁ to C₆ alkyl group and an isomer thereof, and at least one of them is not hydrogen.

In Chemical Formula 3 of the present invention, since the PO⁴⁻ group may easily form a complex through coordination with various metals, molecular weight complexes are also possible, and the appropriate equivalent ratio of the metal catalyst and phosphorus is an important factor in forming a product and improving melt resistivity. In other words, the lower the equivalent ratio of phosphorus and metal, the lower the melt resistivity, so it may be designed by appropriately changing the equivalent ratio in consideration of the above effect.

The phosphorus compound may be included so that the content of phosphorus atoms is 10 to 30 ppm based on the mass of the finally obtained polyester resin composition. When the content of the phosphorus compound is less than 5 ppm relative to the mass of the polyester resin composition, the phosphorus compound does not sufficiently serve as a thermal stabilizer, which may decrease the heat resistance of the polyester resin. When the content of the phosphorus compound exceeds 30 ppm, melt resistivity greatly increases, reducing the usability as a film, and a large amount of highly insoluble foreign substances may be produced, thereby affecting transparency.

Meanwhile, the purpose of the present invention may be achieved when the polyester resin composition for films of the present invention satisfies all of the following relational expressions (1) to (3):

$$M = 1 to 150 ppm \qquad ( 1 )$$

$$T = 1 to 40 ppm \qquad ( 2 )$$

$$R is 10 MΩ \cdot cm or less \qquad ( 3 )$$

wherein M refers to the total content of metal components excluding phosphorus (P) in the polyester resin composition, T refers to the content of titanium based on elemental titanium, and R refers to melt resistivity.

The above relational expression (1) is explained. The total content of metal components (M) includes metal components in the final product and metal components in impurities (definition). In other words, the total content of metal components (M) refers to all metal components excluding phosphorus in the polyester resin composition and may be, for example, the total of the titanium metal content, magnesium content, and the like in the composition.

These metal components may react with bis-2-hydroxyethyl terephthalate (BHT), which is generated during the polyester polymerization process, to form compounds such as BHT-P complex and BHT-Metal-P or react with titanium used as a catalyst to form foreign substances. These foreign substances may act as defects in the manufactured polyester resin and physical properties may deteriorate due to reduced cleanliness.

Thus, the metal components are included in an amount of 0.01 to 150 ppm. When the content exceeds 150 ppm, a large number of foreign substances are formed in the polyester resin, which significantly decrease the degree of polymerization, making it difficult to achieve viscosity and required chemical/physical properties, and metals may precipitate or form complexes in the resin, causing internal defects. Thus, the transparency of the film manufactured therefrom may decrease, and haze may occur. More preferably, the metal components may be included in an amount of 0.01 to 100 ppm in consideration of the role of phosphorus as a metal sequestering agent, which will be described later.

Hereinafter, the relational expression (2) is explained.

The titanium content (T) is 1 to 40 ppm in the polyester resin composition based on elemental titanium. When the titanium content is less than 1 ppm, it may be difficult to properly promote the esterification reaction, and when the titanium content exceeds 40 ppm, reactivity is promoted, but there may be a problem of coloring.

Conventionally, titanium alkoxide is a water-insoluble material and has difficulty in handling when applied to the process. The catalyst applied in the present invention is a water-soluble material and is stable even in the presence of water molecules and has high activity during a polymerization reaction. The catalyst may be preferably included in an amount of 1 to 15 ppm and more preferably in an amount of 10 to 25 ppm, which may exhibit the best catalytic activity and at the same time reduce the metal content.

Hereinafter, the melt resistivity (R) of the relational expression (3) is explained.

Melt resistivity is one of the physical properties of polyester resin and serves as an indicator of electrostatic adhesion when manufacturing a film using a polyester resin through the electrostatic casting method. The smaller the melt resistivity value, the better the electrostatic adhesion, so a film with a uniform thickness may be obtained during the casting process, and the production speed may be increased as the rotational speed is affected.

The polyester resin composition according to the present invention may have a melt resistivity of 0.01 to 10 MΩ·cm. When the melt resistivity exceeds 10 MΩ·cm, static electricity is not sufficiently deposited on the surface of the sheet (film), and thus it is impossible to exhibit good electrostatic adhesion. In other words, during the casting process, air bubbles are generated between the rotating cooling drum and the sheet, making it impossible to obtain a film with a uniform thickness and affecting the yield due to a decrease in production speed. When the melt resistivity is less than 0.01 MΩ·cm, adhesion decreases during the film casting process, and thus casting is not good. Thus, in order to exhibit good electrostatic adhesion and not reduce the physical properties of the film, the range of melt resistivity may be preferably 0.1 to 3 MΩ·cm.

The polyester resin composition for films according to an embodiment of the present invention may further include a coloring agent to improve the optical properties of the film. To this end, a coloring agent including blue and red dyes may be further included in an amount of 1 to 10 ppm based on the total weight of the polyester resin composition.

The coloring agent may be one known in the textile field, and non-limiting examples may include all-purpose dyes, pigments, vat dyes, disperse dyes, and organic pigments. However, it is preferable to use a mixture of blue and red dyes. This is because cobalt compounds, which are commonly used as a coloring agent, are undesirable because they are very harmful to the human body, whereas the coloring agent, in which blue and red dyes are mixed, is desirable because it is harmless to the human body. In addition, when a mixture of blue and red dyes is used, the color may be finely adjusted. The blue dye may be, for example, solvent blue 104, solvent blue 122, solvent blue 45, and the like, and the red dye may be, for example, solvent red 111, solvent red 179, solvent red 195, and the like.

When the content of coloring agent in the composition exceeds 10 ppm, dispersibility may decrease and foreign substances may be generated or dispersed. On the other hand, when the content of coloring agent in the composition is less than 1 ppm, titanium may have a unique yellow color, which may hinder its full use in optical films where slight differences in color tone are problematic. The coloring agent may be preferably included in an amount of 2 to 8 ppm for the dispersibility and balance of color tone.

When the color coordinate b value of resin exceeds 8 due to the coloring agent, the film color is affected, which is not suitable for optical films that require transparency, and the color of the film surface as well as the color of the sides of the film are changed, which may cause appearance defects. Thus, the color coordinate b value may be preferably 8 or less.

As described above, the metal component (M) reduces the physical properties of the polycondensed polyester resin by inhibiting the activity of the catalyst or forming foreign substances, but the use of metals such as the catalyst and the pinning agent is essential for more efficient polyester polycondensation.

In this case, phosphorus (P) may additionally serve as a metal ion sequestering agent, which prevents the formation of foreign substances by reacting with the above-described metal components in addition to serving as a thermal stabilizer. Metal ion sequestering agents are mainly used to reduce the activity of metal ions by chemically acting on them or to increase the yield of the target compound by lowering the content of impurities. Therefore, when the optimal content ratio of metal components and phosphorus (P) is known, it is possible to improve the physical properties of polyester and simultaneously minimize the formation of foreign substances due to metal ions.

According to an embodiment of the present invention, the polyester resin composition of the present invention may additionally satisfy the following relational expression (4).

$$P / M = 0.1 to 0.6 \qquad ( 4 )$$

When the content ratio of metal ions and phosphorus in the composition exceeds 0.6, melt resistivity increases, which may cause problems such as an uneven film thickness or poor casting during the film casting process. When the content ratio of metal ions and phosphorus in the composition is less than 0.1, phosphorus may not sufficiently serve as a metal ion sequestering agent, and thus foreign substances may be formed, and the physical properties of the polyester resin itself may deteriorate. In addition, the amount of phosphorus compound used is preferably 10 to 30 ppm based on phosphorus atoms for the polymer obtained after polymerization.

The polyester resin prepared according to an embodiment of the present invention may include 1 to 45 terminal carboxyl groups. As described above, when using the polyester resin composition according to the present invention, it is possible to perform polymerization at a low temperature and have a high degree of polymerization, thereby additionally reducing the polymer terminal group (COOH). Thus, it is possible to perform a more stable process and increase the production speed.

The polyester resin prepared according to an embodiment of the present invention may have an intrinsic viscosity of 0.300 to 0.900 dl/g. When the intrinsic viscosity is lower than 0.300 dl/g, the viscosity is insufficient, and thus a large number of bubbles are generated due to the low viscosity during the film casting process. When the intrinsic viscosity is higher than 0.900 dl/g, the viscosity is high, and thus the film may not be cast evenly during the casting process. More preferably, the intrinsic viscosity may be 0.500 to 0.800 dl/g.

As such, the polyester resin composition according to the present invention provides an optimal polyester resin for films by adjusting the content of other metal additives including the titanium-based chelate catalyst.

Hereinafter, a film manufactured using the polyester resin according to the present invention will be described.

In general, films made of polyester are widely used in various industrial fields such as magnetic recording media, condensers, optics, and general industrial purposes due to their excellent mechanical properties, thermal properties, chemical resistance, and electrical properties. Polyester films are generally obtained by melting and extruding a polyester resin using an extruder and then biaxially stretching the same in the transverse/longitudinal directions.

At this time, since the polyester resin is melted and extruded at a temperature above the melting point of polyester resin, which is 250 to 300° C., during the molding process of the polyester film, the polyester resin may be thermally decomposed, and when a trace amount of oxygen is mixed, gel-type foreign matter may be generated due to oxidative decomposition, which may act as internal defects in the molded film.

When forming a polyester resin into a film, the electrostatic application casting method is mainly used, in which a high voltage is applied to the upper surface of the sheet-type product, and the sheet-type product is brought into close contact with a rotating cooling drum, but when the speed of the rotating cooling drum increases to increase the film forming speed, the close contact between the sheet-type film and the rotating cooling drum may decrease, and thus the thickness uniformity or transparency of the film may decrease, and defects may occur on the surface of the film due to uneven application. In particular, in recent years, films for magnetic recording media or dry film resists require a high degree of surface smoothness or thinning, so the above-described gel-type foreign matter or poor electrostatic application property, which worsens the surface defects and transparency of the film, are undesirable.

Thus, the present invention is intended to provide a solution for the conventional problems by manufacturing a film using the polyester resin, which is prepared using the above-described polyester composition for films according to the present invention. To avoid overlapping content, description of the polyester resin composition for films and the polyester resin prepared therefrom will be omitted.

When manufacturing a film through the electrostatic application casting method using the polyester resin, which is prepared using the above-described polyester composition for films according to the present invention, due to high electrostatic adhesion without a gap between the sheet-type film and the rotating cooling drum, it is possible to achieve uniform casting even when the rotational speed of the rotating cooling drum increases.

In other words, when the polyester resin according to the present invention satisfies the conditions of the above-described relational expressions (1) to (3), the amount of charge on the film surface increases, and thus the electrostatic application properties become excellent due to exhibiting high electrostatic adhesion, and as a result, a gap between the drum surface and the sheet-type film is not formed even at high rotational speeds, making it possible to manufacture a uniform and highly transparent film.

In addition, during the polycondensation process, a highly polymerized polyester resin with a low content of terminal carboxyl groups may be obtained, and due to low melt resistivity, film molding may be performed even at low temperatures, making it possible to manufacture a film with excellent heat resistance.

In the present invention, the polyester film may be manufactured using the polyester composition through a conventional manufacturing method such as melt-extruding the polyester composition using a commonly known T-die method to obtain an unstretched sheet, stretching the obtained unstretched sheet 2 to 7 times, preferably 3 to 5 times, in the machine direction, and then stretching the same 2 to 7 times, preferably 3 to 5 times, in the transverse direction.

Hereinafter, the method of preparing a polyester resin for films will be described.

The method includes (1) preparing an esterification reaction product from the esterification reaction of an acid component and a diol component and (2) preparing a polyester resin by adding a titanium-based chelate catalyst, a pinning agent, and a phosphorus-based compound to the prepared esterification reaction product, and the polyester resin satisfies all of the following relational expressions (1) to (3):

$$M = 1 to 150 ppm \qquad ( 1 )$$

$$T = 1 to 40 ppm \qquad ( 2 )$$

$$R is 10 MΩ \cdot cm or less . \qquad ( 3 )$$

Here, M refers to the total content of metal components excluding phosphorus (P) in a polyester resin composition, T refers to the content of titanium based on elemental titanium, and R refers to melt resistivity. To avoid overlapping content, description of the above-described polyester resin composition for films and the polyester resin prepared therefrom will be omitted.

In step (1), the acid component and diol component may be esterified to obtain an esterification reaction product using known synthesis conditions in the field of polyester synthesis. The acid component and the diol component may be added so that they react at a molar ratio of 1:1.1 to 2.0, but are not limited thereto.

The esterification reaction may be preferably performed at a temperature of 200 to 270° C. and a pressure of 1100 to 1350 Torr. When the above conditions are not met, the esterification reaction time may be prolonged or an esterification compound suitable for the polycondensation reaction may not be formed due to reduced reactivity. The polycondensation reaction may be performed at a temperature of 250 to 300° C. and a pressure of 0.3 to 1.0 Torr, and when the above conditions are not met, the polycondensation reaction time may be delayed, the degree of polymerization may decrease, and thermal decomposition may occur.

Next, in step (2), the esterification reaction product prepared in the above-described step (1) is condensed into a polyester resin by adding the titanium-based chelate catalyst, the pinning agent, and the phosphorus-based compound according to the present invention.

The titanium-based chelate catalyst may be a reaction product of titanium-(IV)-alkoxide represented by the following Chemical Formula 1 and alpha-hydroxy carboxylic acid, and the phosphorus-based compound may be represented by the following Chemical Formula 3. When applying the titanium-based chelate catalyst, the reaction rate is faster than when applying an Sb catalyst, so polycondensation is possible even at low temperatures.

The reaction product may be titanium alpha-hydroxy carboxylate represented by the following Chemical Formula 2.

Ti—(OR₁)₄ [Chemical Formula 1]

Here, R₁ is a C₁ to C₆ alkyl group.

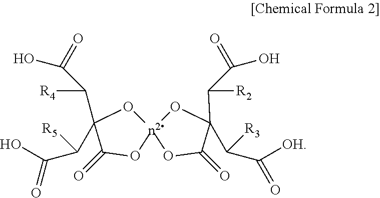

Here, R₂ to R₅ are each independently hydrogen or a C₁ to C₆ alkyl group.

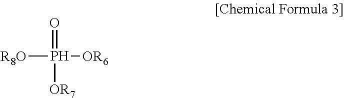

Here, R₆ to R₈ are each independently hydrogen or a C₁ to C₆ alkyl group, and at least one of them is not hydrogen.

As described above, the polyester resin composition for films according to the present invention may be manufactured into a polyester resin for films and a film manufactured therefrom with excellent thermal stability and melt resistivity while increasing production speed and yield by including a titanium-based chelate catalyst, a pinning agent, and a phosphorus-based compound and presenting an optimal content ratio thereof.

### MODES OF THE INVENTION

### [Example 1] Preparation of Polyester Resin

100% of terephthalic acid (TPA) as an acid component and 100 mol % of ethylene glycol (EG) as a diol component were added to an esterification tank and allowed to react at 250° C. and 1140 Torr to obtain an esterification reaction product. The acid component and diol component were added at a molar ratio of 1:1.2.

The formed esterification reaction product was transferred to a polycondensation reactor, and 20 ppm of a titanium-based chelate catalyst represented by Chemical Formula 2 below, which was a reaction product of a compound represented by Chemical Formula 1-1 below and alpha-hydroxy carboxylic acid, was added as a polycondensation catalyst, and 25 ppm of triethyl phosphate (based on elemental P) was added as a thermal stabilizer, and a polycondensation reaction was performed while gradually reducing the pressure to a final pressure of 0.5 Torr and increasing the temperature to 280° C. to prepare a polyester resin:

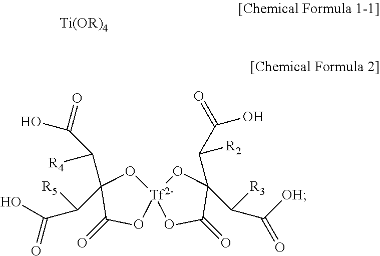

wherein all of R₂ to R₄ are hydrogen.

### [Examples 2 to 10] Preparation of Polyester Resin

Polyester resins were prepared in the same manner as in Example 1, except that the content of metal or magnesium was changed, which is shown in Table 2.

### [Examples 11 and 12] Preparation of Polyester Resin

Polyester resins were prepared in the same manner as in Example 1, except that the content of titanium-based chelate catalyst was changed, which is shown in Table 2.

### [Experimental Example 1] Measurement of Melt Resistivity

A fixed amount of polyester resin according to the examples of the present invention was added to a glass tube, placed in a melting bath, and melted. After masking with a Teflon tape so that only the measurement part of the electrode was electrically conductive, a measuring probe (electrode) was inserted into the melted polymer to transfer the charge. After pressing the start button of the resistance measurement software and stabilizing the polymer for 10 minutes, the resistance value was recorded.

### [Experimental Example 2] Measurement of Intrinsic Viscosity

Each polyester resin prepared in Examples was melted in an ortho-chloro phenol solvent at a concentration of 2.0 g/25 ml at 110° C. for 30 minutes, and incubated at 25° C. for 30 minutes, and then intrinsic viscosity was measured using an automatic viscosity measurement device connected to a CANON viscometer.

### [Experimental Example 3] Quantification of Carboxyl Terminal Group

The carboxyl group content of Examples was measured according to the following method. After 0.15 g of polyester powder, which was ground to a 20-mesh size, was precisely weighed and placed in a test tube, 5 ml of benzyl alcohol was added to the test tube, and the mixture was heated and dissolved at 210° C. for 1300 seconds while stirring with an ultra-small stirrer. Immediately after dissolution, the test tube was rapidly cooled by immersion in water at 25° C. for 6 seconds, and then the content was poured into a 50 ml beaker containing 10 ml of chloroform. Afterward, 5 ml of benzyl alcohol was added to the test tube and stirred for 60 seconds to thoroughly rinse the remaining polyester resin solution. The carboxyl group content was neutralized and titrated with a 0.1 N sodium hydroxide benzyl alcohol solution using a microsyringe (capacity: 100 μl) with phenol red (0.1% benzyl alcohol solution) as an indicator, and the titration value was corrected according to the results of the blank test for the titration reagent and the carboxyl group content was calculated according to Equation 1 below.

$$Carboxyl group content ( eq . / {10}^{6} g PET ) = [ \text{} Volume of titrant ( μ 1 ) - Blank test result ( μ 1 ) ] \times 0.1 \times f / Weight of PET sample \qquad [ Equation l ]$$

Here, f is the concentration coefficient of the 0.1 N sodium hydroxide benzyl alcohol solution.

### [Experimental Example 4] Number of Internal Defects

To measure the number of internal defects, the polyester resin prepared according to the present invention was melted on a slide glass to prepare a 500 μm-thick sample. The defects in the 180 μm-deep layer of the sample were observed at a magnification of 200× in transmitted light using an optical microscope, and then the number of defects with a size of 1.5 μm or more in a 448 μm×336 μm area was calculated by averaging the number of defects in a total of 5 micrographs. In addition, the size of the defect can be measured using a microscope scale bar and was measured based on the long axis of the defect.

### [Experimental Example 5] Measurement of Film Haze

The polyester resin was melted through a T-die for an extruder using a pilot film manufacturing machine and cooled with a casting drum to manufacture a 1690 μm-thick sheet, and then the manufactured sheet was stretched transversely and longitudinally 3 times to manufacture a 188 μm sheet, and the haze of the film was measured.

The haze was measured according to ASTM D-1003, and 7 parts were randomly extracted from two locations on the edges and one location in the center and cut into 5 cm×5 cm pieces. Afterward, each piece was placed in a haze meter (NDH 300A from Nippon Denshoku Industries Co., Ltd.), light with a wavelength of 555 nm was transmitted therethrough, and then the average value excluding the maximum/minimum values was calculated using Equation 2 below.

$$Haze ( \% ) ( Totally scattered light / Totally transmitted light ) \times 100 \qquad [ Equation 2 ]$$

TABLE 1

| | | | | | | Metal |
|---|---|---|---|---|---|---|
| | | Types of | | Titanium | | content |
| | Types of | titanium | | chelate | | (M)/phosphorus |
| | titanium | chelate | Metal | catalyst | Magnesium | content |
| Examples | alkoxide | catalyst | content (M) | content (T) | content | (P) |
| Example 1 | Chemical | Chemical | 86 | 20 | 3 | 0.87 |
| | Formula 1 | Formula 2 | | | | |
| Example 2 | Chemical | Chemical | 110 | 20 | 15 | 0.68 |
| | Formula 1 | Formula 2 | | | | |
| Example 3 | Chemical | Chemical | 140 | 20 | 30 | 0.54 |
| | Formula 1 | Formula 2 | | | | |
| Example 4 | Chemical | Chemical | 160 | 20 | 40 | 0.47 |
| | Formula 1 | Formula 2 | | | | |
| Example 5 | Chemical | Chemical | 180 | 20 | 50 | 0.42 |
| | Formula 1 | Formula 2 | | | | |
| Example 6 | Chemical | Chemical | 200 | 20 | 60 | 0.38 |
| | Formula 1 | Formula 2 | | | | |
| Example 7 | Chemical | Chemical | 220 | 20 | 70 | 0.34 |
| | Formula 1 | Formula 2 | | | | |
| Example 8 | Chemical | Chemical | 320 | 20 | 120 | 0.23 |
| | Formula 1 | Formula 2 | | | | |
| Example 9 | Chemical | Chemical | 160 | 20 | 40 | 0.47 |
| | Formula 1 | Formula 2 | | | | |
| Example 10 | Chemical | Chemical | 160 | 20 | 40 | 0.47 |
| | Formula 1 | Formula 2 | | | | |
| Example 11 | Chemical | Chemical | 82 | 0.5 | 40 | 0.91 |
| | Formula 1 | Formula 2 | | | | |
| Example 12 | Chemical | Chemical | 300 | 55 | 40 | 0.25 |
| | Formula 1 | Formula 2 | | | | |

TABLE 2

| | Intrinsic | Measurement | Melt | Number |
|---|---|---|---|---|
| | viscosity | of terminal | resistivity ® | of internal |
| Examples | (dl/g) | groups | (MΩ · cm) | defects |
| Example 1 | 0.45 | 21.5 | 3.6 | Good |
| Example 2 | 0.48 | 27.5 | 1.9 | Good |
| Example 3 | 0.52 | 35 | 0.8 | Good |
| Example 4 | 0.38 | 40 | 1.4 | Good |
| Example 5 | 0.46 | 45 | 2.2 | Good |
| Example 6 | 0.25 | 50 | 2.5 | Good |
| Example 7 | 0.85 | 55 | 7 | Good |
| Example 8 | 1.11 | 80 | 9 | Poor |
| Example 9 | 0.5 | 40 | 4 | Fair |
| Example 10 | 0.45 | 40 | 6 | Fair |
| Example 11 | 0.99 | 20.5 | 11 | Poor |
| Example 12 | 1.03 | 75 | 14 | Poor |

Referring to Table 1 and Table 2, it can be seen that in Examples 3 and 4 which satisfied all numerical ranges of the present invention, all physical properties were excellent. In other words, it can be seen that in Examples 5 to 8 which had a high metal content, melt resistivity was high or defects appeared in the internal defect test. In addition, it can be seen that in Examples 11 and 12, in which a titanium chelate catalyst content was outside the numerical range of the present invention, all physical properties were significantly low.

1. A polyester resin composition for films comprising:
a polyester resin polycondensate;
a titanium-based chelate catalyst;
a pinning agent; and
a phosphorus-based compound, and satisfying all of the following relational expressions (1) to (3):
$$M = 1 to 150 ppm \qquad ( 1 )$$
$$T = 1 to 40 ppm \qquad ( 2 )$$
$$R is 10 MΩ \cdot cm or less , \qquad ( 3 )$$
wherein M refers to the total content of metal components excluding phosphorus (P) in the polyester resin composition, T refers to the content of titanium based on elemental titanium, and R refers to melt resistivity.

2. The composition of claim 1, wherein the composition satisfies the following relational expression (4):
$$P / M = 0.1 to 0.6 , \qquad ( 4 )$$
wherein P refers to the amount of elemental phosphorus in the phosphorus-based compound.

3. The composition of claim 1, wherein the titanium-based chelate catalyst is a reaction product of titanium-(IV)-alkoxide represented by the following Chemical Formula 1 and alpha-hydroxy carboxylic acid:
Ti—(OR₁)₄ [Chemical Formula 1]
wherein R₁ is each independently hydrogen or a C₁ to C₆ alkyl group, and at least one of them is not hydrogen.

4. The composition of claim 3, wherein the reaction product is titanium alpha-hydroxy carboxylate represented by the following Chemical Formula 2: 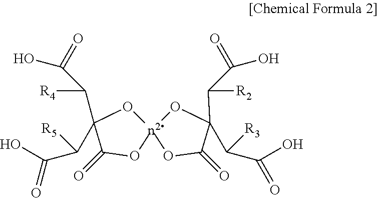
wherein R₂ to R₅ are each independently hydrogen or a C₁ to C₆ alkyl group and an isomer thereof.

5. The composition of claim 1, wherein the phosphorus-based compound is represented by the following Chemical Formula 3: 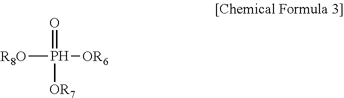
wherein R₆ to R₈ are each independently a C₁ to C₆ alkyl group and an isomer thereof.

6. The composition of claim 1, wherein the pinning agent is a magnesium (Mg)-based compound.

7. The composition of claim 1, further comprising a coloring agent including blue and red dyes in an amount of 1 to 10 ppm based on the total weight of the polyester resin composition.

8. A polyester resin for films prepared using the polyester resin composition of claim 1 and having 1 to 45 terminal carboxyl groups.

9. A film manufactured from the polyester resin of claim 8.

10. A method of preparing a polyester resin for films, the method comprising:
(1) preparing an esterification reaction product from the esterification reaction of an acid component and a diol component; and
(2) preparing a polyester resin by adding a titanium-based chelate catalyst, a pinning agent, and a phosphorus-based compound to the prepared esterification reaction product, the polyester resin satisfying all of the following relational expressions (1) to (3):
$$M = 1 to 150 ppm \qquad ( 1 )$$
$$T = 1 to 40 ppm \qquad ( 2 )$$
$$R is 10 MΩ \cdot cm or less , \qquad ( 3 )$$
wherein M refers to the total content of metal components excluding phosphorus (P) in a polyester resin composition, T refers to the content of titanium based on elemental titanium, and R refers to melt resistivity.

11. The method of claim 10, wherein the titanium-based chelate catalyst is a reaction product of titanium-(IV)-alkoxide represented by the following Chemical Formula 1 and alpha-hydroxy carboxylic acid, and the phosphorus-based compound is represented by the following Chemical Formula 3:
Ti—(OR₁)₄ [Chemical Formula 1]
wherein R₁ is a C₁ to C₆ alkyl group,

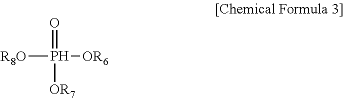

12. The method of claim 10, wherein the reaction product is titanium alpha-hydroxy carboxylate represented by the following Chemical Formula 2: 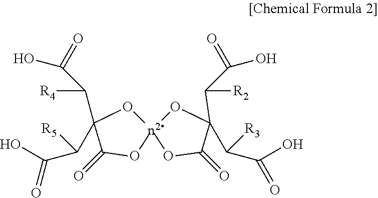
wherein R₂ to R₅ are each independently hydrogen or a C₁ to C₆ alkyl group.
